(19) United States
(12) Patent Application Publication
(10) Pub. No.: US 2016/0042473 A1
(43) Pub. Date: Feb. 11, 2016

(54) METHOD FOR MANAGING VIA WEB DATA RELATED TO AN EVENT AND/OR A PERSON AND/OR AN ORGANIZATION

(71) Applicants: Alberto DANIELLI, (US); Daniele REBECHI, (US)

(72) Inventors: Alberto DANIELLI, Burlington, NC (US); Daniele REBECHI, Vicopisano (IT)

(21) Appl. No.: 14/378,907

(22) PCT Filed: Feb. 15, 2013
(86) PCT No.: PCT/IB2013/051259

§ 371 Date: Aug. 14, 2014

Related U.S. Application Data
(60) Provisional application No. 61/600,051, filed on Feb. 17, 2012.

(51) Int. Cl. G06Q 50/00; H04L 29/08; G06F 3/0484; H04L 12/58

(52) U.S. Cl. CPC G06Q 50/01; H04L 51/046; H04L 67/02; G06F 3/04847

(57) ABSTRACT

A method for managing data concerning an event, in particular a sport event and/or an individual, in particular an athlete, and/or an organization through a Internet network and for transmitting a stream of audio and/or video data concerning the event on at least one streaming channel.

### FIELD OF THE INVENTION

The present invention relates to the field of social networks and, in particular, it relates to a method for managing data concerning an event, for example a sport event, and/or concerning an individual, for example an athlete, and/or concerning an organization, for example a sporting federation, through an Internet network.

### DESCRIPTION OF THE PRIOR ART

As well known, web pages exist that are dedicated to an event, such as a sport event, or a public show of other kind, for example concerts, or to determined individuals, for example athletes, but also directors, actors, writers, on which data and information are loaded concerning the event, or the individual.

The users who are interested in the event, or in the individual, to which a web page is dedicated, periodically search the Internet to know the date of the event, or to listen to news, or other information of every kind related to the event, or to the individual. For example, if the user follows the activities of an athlete, or of a team, among all the data in which the user can be interested, there are date and time of the competitions to which the athlete, or the team, want to participate.

However, if the individual participates to an occurrence, for example declares that he/she wishes to participate to an event, just before the event same, or if the web page is not updated in real time, the interested user has not the possibility to be informed in time that the followed individual will participate in a certain date to the event. Therefore, the user cannot have the opportunity to watch the event, for example a sport competition, such as a boxing match, transmitted by a television station, or radio station through a broadcasting transmission, or a streaming transmission.

Even if the user knows about the event close to the same, in any case he/she could have difficulties to find for the television, or radio, channel which broadcasts the event, or the streaming channel that transmits the event via web. Therefore, also in this case notwithstanding the user knows of the event in time it is not sure that he/she can watch the event same.

The above described drawbacks are particularly relevant when the individual and/or the event are interesting only for a few users, for example an athlete of a sport discipline having a few followers, or an athlete of semi-professional, or amateur sport level. In this case, in fact, finding web pages dedicated to the desired event and/or individual is difficult, and in any case even if a web page exists that is directly managed by the individual, or by a fan, it is unlikely that the web page is frequently updated.

Furthermore, in this case, it is unlikely that the event is transmitted by a television channel, or radio channel, or even that a streaming channel is provided that transmits the desired event.

### SUMMARY OF THE INVENTION

It is then a feature of the present invention to provide a method for managing data related to an event, in particular a sport event and/or data related to an individual, in particular an athlete, through an Internet network that allows to quickly inform a user about a prearranged date for transmitting, via an internet streaming transmission, an event of his/her interest, or to which an individual of his/her interest participates. It is also a feature of the present invention to provide a method for managing data concerning an event, in particular a sport event and/or an individual, in particular an athlete, through an Internet network that is available easily and quickly for the users.

It is a particular feature of the invention to provide a method for managing data concerning an event, in particular a sport event and/or an individual, in particular an athlete, through an Internet network that allows the users of the service who are followers of a sport event and/or of an athlete to be informed well in advance of any kind of news concerning the sport event and/or the athlete even if the sport event and/or the athlete are not followed by a large number of people.

These and other features are accomplished with one exemplary method, according to the invention, for managing data concerning an event, in particular a sport event and/or an individual, in particular an athlete, and/or an organization, in particular a sport federation, through an Internet network, said method comprising the steps of:
providing a database, said database containing a plurality of data concerning a plurality of events and/or of individuals and/or of organizations;
accessing by a user to a predetermined web page, said access step occurring by an interface device connected to the Internet network, and said user indicating at least one private data item selected from the group consisting of:
   a telephone number;
   a social network to which said user belongs;
   an e-mail address;
selecting by said user, in particular through a front-office interface of said web page, at least one desired event and/or an individual and/or an organization among said plurality of events and/or individuals and/or organizations contained in said database, obtaining a selected event and/or individual and/or organization;
associating said user, by a central control unit, with said, or each, selected event and/or individual and/or organization;
extracting, by said central control unit, the data contained in said database and concerning said selected event and/or individual and/or organization obtaining a plurality of extracted data;
monitoring, by said central control unit, said extracted data;
changing at least one extracted value of said plurality of extracted data obtaining at least one changed extracted value;
detecting said change by said central control unit during said step of monitoring and sending a notification message to said user associated with said, or each, changed extracted value, such that said user associated with said, or each, changed extracted value is informed in good time of said change, said notification message selected from the group consisting of:
   a notification message to said telephone number;
   a notification message to said social network to which said user belongs;
   a notification message to said e-mail address;
   a notification message to a smartphone, or a tablet, of said user through a notification server;
   a combination thereof;
acquisition at least one stream of audio and/or video data concerning said event and/or an event and/or an organization associated with said selected individual, said acquisition step carried out by at least one video camera at a predetermined display resolution;
sending said, or each, stream of audio and/or video data to a predetermined streaming server;
transmitting said, or each, stream of audio and/or video data concerning said, or each, event from said streaming server via at least one streaming channel.

Advantageously, if the notification message is sent through a notification server the steps are provided of:
connecting via Internet said electronic device of said user to a download server, said electronic device associated with a unique identification code;
downloading a predetermined application program by said download server to said electronic device of said user;
installing said application program on said electronic device of said user;
detecting said unique identification code by said application program;
sending said unique identification code by said application program from said electronic device to said central control unit;
associating by said central control unit said unique identification code to said data of said user;
sending to said notification server, when a change of said monitored data is detected by said central control unit, a notification user list, said notification user list containing the unique identification code associated with said user associated with said changed data;
sending said notification message by said notification server to each electronic device associated with a respective unique identification code of said notification user list.

In particular, the electronic device provided with an Internet access can be selected from the group consisting of:
a smartphone;
a tablet;
a notebook;
a PC;
a TV.

Advantageously, an input step is provided of a data item, or a change of at least one data item, by an administrator, said administrator enabled to carry out said input step through a back-office interface of said predetermined web page, said input step causing said change of said data and then generating said modified data.

In particular, the input step provides the following operations:
input by said administrator of an event in said database and indicating at least one time value, in particular a data and/or a time of said event, said event selected from the group consisting of:
   a single match;
   a plurality of matches;
   a plurality of matches organized as a tournament bracket;
   a plurality of matches organized as a championship;
   a combination thereof;
subscription by an individual and/or of an organization to said event.

In a possible exemplary embodiment, the step of sending said notification message to said user is made directly by said central control unit, said notification message selected in this case among:
a notification message to said social network to which said user belongs;
a notification message to said e-mail address;
an SMS, or an MMS, sent to said telephone number of said user;
a combination thereof.

However, it can be also provided that the central control unit is configured to send a first notification message, said first notification message selected from the group consisting of:
a notification message to said social network to which said user belongs;
a notification message to said e-mail address;
and that the notification server is configured to send a second notification message to said electronic device of said user according to the above described procedure.

Advantageously, the notification message is associated with a visual and/or sound alarm adapted to warn said user associated with said changed data that the notification message has been received by an interface device.

In particular, between the acquisition step and the transmitting step a processing step by a program means is provided of said stream of audio and/or video data, said processing step adapted to compress said stream of audio and/or video data for reducing said display resolution of said stream of audio and/or video data from said predetermined display resolution to a predetermined final resolution.

Advantageously, the predetermined final resolution is determined on the basis of a plurality of predetermined parameters associated with said data concerning said event and/or said individual, the higher said predetermined parameters the higher said display resolution.

In particular, before the selecting step the preliminary steps are provided of:
subscription by said user through said predetermined web page to said management service of events, said enrolment comprising an input step of personal data of said user, said personal data comprising:
a user name;
an alphanumeric code of access, or password;
and at least one additional personal data item selected from the group consisting of:
   an e-mail address;
   a telephone number of said user;
   an indication of a social network to which said user belongs;
   a user geographic area, in particular an address of residence, or an address of domicile, or an IP address from which said user connects to said web page through said electronic device of interface.

In particular, the step of access of the user to the web page of interface provides the step of:
logging in of said recorded user to said predetermined web page through said interface device using a user name and an alphanumeric code of access, or password.

Advantageously, the central control unit, once detected a change in the data, is configured to compute the waiting time to the event, said sending step of said notification message being carried out when said computed waiting time to a determined event, or associated with said selected individual, or to said organization, is less than a predetermined threshold time value t*.

In particular, when the waiting time to said determined selected sport event is less than the threshold time value t*, a procedure is provided comprising a plurality of sending steps of notification messages, said plurality of sending steps comprising a predetermined number of sending steps at predetermined intervals of time.

Advantageously, when the central control unit detects said change the following steps are, furthermore, provided:
accessing by said central control unit and/or said electronic device provided with an Internet access, to a contact book of said associated user, said contact book selected from the group consisting of:
a contact book of said telephone number;
a contact book of said social network to which said user belongs;
a contact book of said e-mail address of said notified user;
and a sending step of an additional notification message to at least one contact of said contact book, said additional notification message selected from the group consisting of:
   a notification message to said telephone number;
   a notification message to said social network to which said user belongs;
   a notification message to said e-mail address;
   a combination thereof.

Advantageously, the streaming channel is integrated in the predetermined web page available via Internet by said users.

The notification message can contain a link to the predetermined web page in which the streaming channel is integrated.

In particular, the method can provide at least one user that has a contract with the service selected from the group consisting of:
a television transmitting station;
a radio transmitting station;

said user that has a contract with the service adapted to transmit said selected sport event via an own channel that has a contract with the service, in particular a satellite channel, or digital terrestrial channel, or a streaming channel through the streaming server.

It can be in any case also provided that the user that has a contract with the service is a media of other kind, for example a newspaper. Furthermore, the streaming server can transmit the stream of audio and/or video data to a stream control and conversion unit, in order to be transmitted through a digital television channel, or digital terrestrial channel.

In particular, the acquisition step is carried out by means of a plurality of video cameras, each video camera of said plurality adapted to take a stream of audio and/or video data concerning a same event to a respective predetermined display resolution, or dimension, obtaining a plurality of streams of audio and/or video data that are sent to said streaming server, said streaming server adapted to select at least one stream of audio and/or video data of said plurality on the basis of said display resolution, or dimension and to transmit said selected stream of audio and/or video data of said plurality to a respective streaming channel.

Advantageously, the acquisition step is carried out by means of a plurality of video cameras, each video camera of said plurality arranged to acquire said event at a predetermined display resolution and wherein in said web page of interface a list of said plurality of video cameras with the related resolution of acquisition is shown, said user enabled to select a video camera from said plurality in such a way that views said transmission streaming of said event at the resolution associated with said selected video camera.

In particular, the predetermined final resolution can be determined on the basis of a plurality of predetermined parameters associated with said data concerning said event and/or said individual and/or said organization, the higher the value of said predetermined parameters the higher said display resolution.

Advantageously, the processing step is adapted to compress said stream of audio and/or video data up to a determined final resolution that is compatible with the size of the band available to the streaming server for said transmission.

According to another aspect of the invention, the sending step of said stream of audio and/or video data of said event to said streaming server is preceded by an activation step, said activation step comprising the following steps:
arranging at least one identification element on a garment, or an accessory, worn by at least one individual who participates to said event, said identification element containing an identification code;
reading said identification code by a reader device;
transmitting said identification code to a control means, said control means adapted to carry out a verification step during which a read identification code is compared with a predetermined identification code, said sending step of said stream of audio and/or video data occurring if said verification step has a positive result.

In an exemplary embodiment the identification element can contain a biometric value, or a bar code, or a QR code, or an identification number.

In particular the reader device and said identification element are configured to communicate with each other via a radio transmission, or a transmission of a biometric value, or a transmission of a bar code, or a transmission of a QR code, or a transmission of an identification number.

Advantageously, the steps are provided of:
arranging a first NFC device, or Near Field Communication, on a garment, or an accessory, worn by a first individual who participates to said event, said first NFC device comprising a first NFC sensor;
arranging a second NFC device, or Near Field Communication, on a garment, or an accessory, worn by a second individual who participates to said event, said second NFC device comprising a second NFC sensor;
carrying out an NFC communication between said first and said second NFC sensor, when said first and said second NFC device are arranged within a determined distance;
authenticating said first and of said second individual on the basis of said NFC communication and providing an authorization to send said stream of audio and/or video data if said authentication has a positive result.

Advantageously, a loading step is, furthermore, provided of said data on said database, said loading step being carried out by a user selected from the group consisting of:
an administrator having preliminary authorization;
at least one individual;
at least one organization,
a combination thereof.

### BRIEF DESCRIPTION OF THE DRAWINGS

The invention is shown hereafter with the following description of an exemplary embodiment thereof, exemplifying but not limitative, with reference to the attached drawings, in which:

FIG. 1A diagrammatically shows the main phases provided by the method, according to the invention, for managing data concerning an event and/or an individual through an Internet network;

FIGS. 1B and 1C diagrammatically show two exemplary embodiments of the method of FIG. 1A for managing data concerning an event and/or an individual through an Internet network;

FIG. 2 diagrammatically shows in detail the acquisition step of the stream of audio and/or video data of the event and of transmission of the stream same via a streaming channel;

FIG. 3 diagrammatically shows an exemplary embodiment of the acquisition step, shown in FIG. 2, of the stream of audio and/or video data of the event and of transmission of the same through a streaming channel;

FIGS. 4 and 5 diagrammatically show a possible image that can be displayed on an interface device that can be used by a user to connect to the web page of interface through which a user can connect to the service;

FIG. 6 diagrammatically shows a possible step provided by the method, according to the invention, for gaining access to the contact book of the user for sending notification messages to the contacts of the contact book;

FIGS. 7 and 8 diagrammatically show the main steps provided by particular exemplary embodiments of the method, according to the invention;

FIG. 9 diagrammatically shows an exemplary embodiment of the present invention that provides a notification server for sending the notification message to the users;

FIGS. 10A and 10B diagrammatically show further exemplary embodiments of the present invention;

FIGS. 11 and 12 diagrammatically show the main hardware components involved in a further exemplary embodiment by the method, according to the invention;

FIGS. 13 to 17 diagrammatically show further aspects of the method for managing data via web, according to the present invention.

### DETAILED DESCRIPTION OF SOME EXEMPLARY EMBODIMENTS

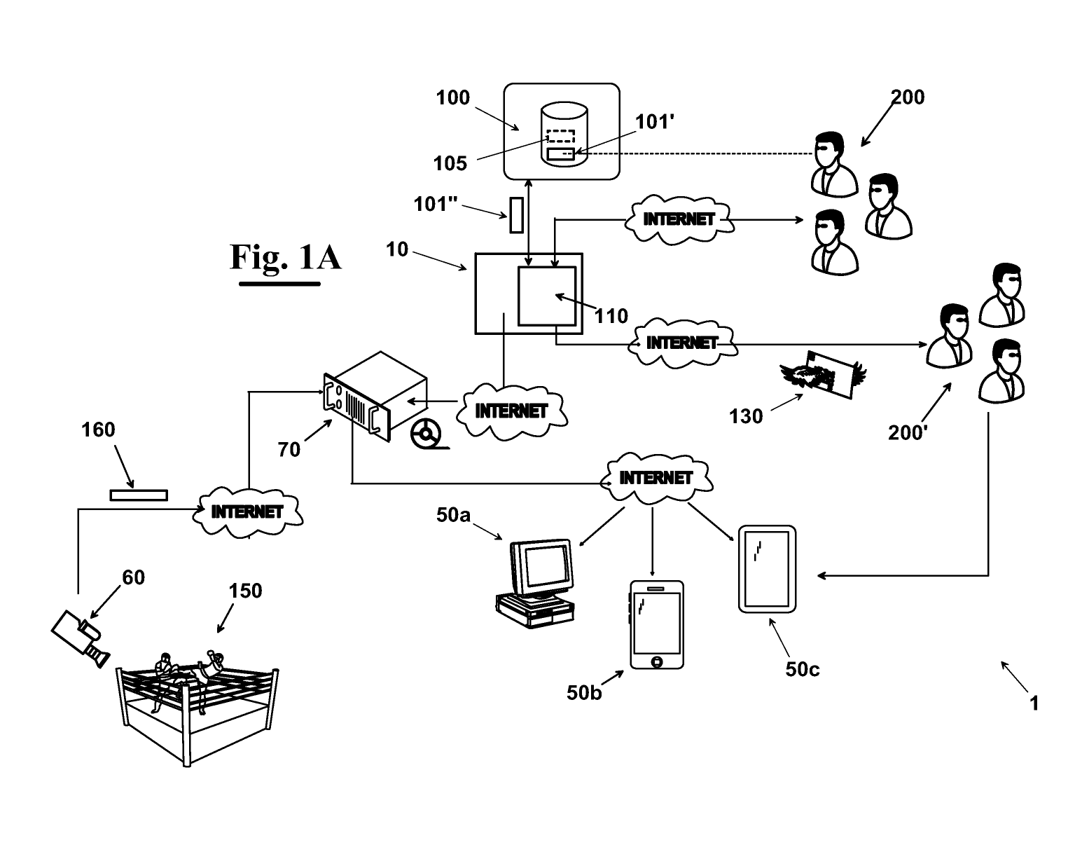

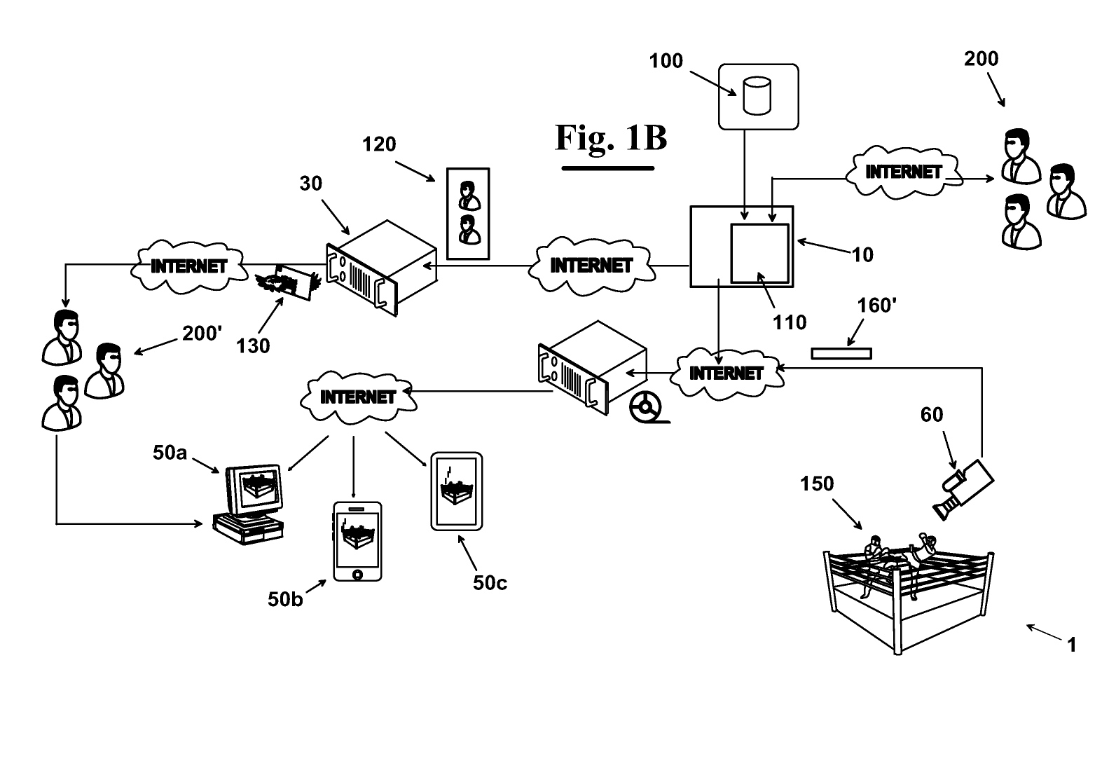

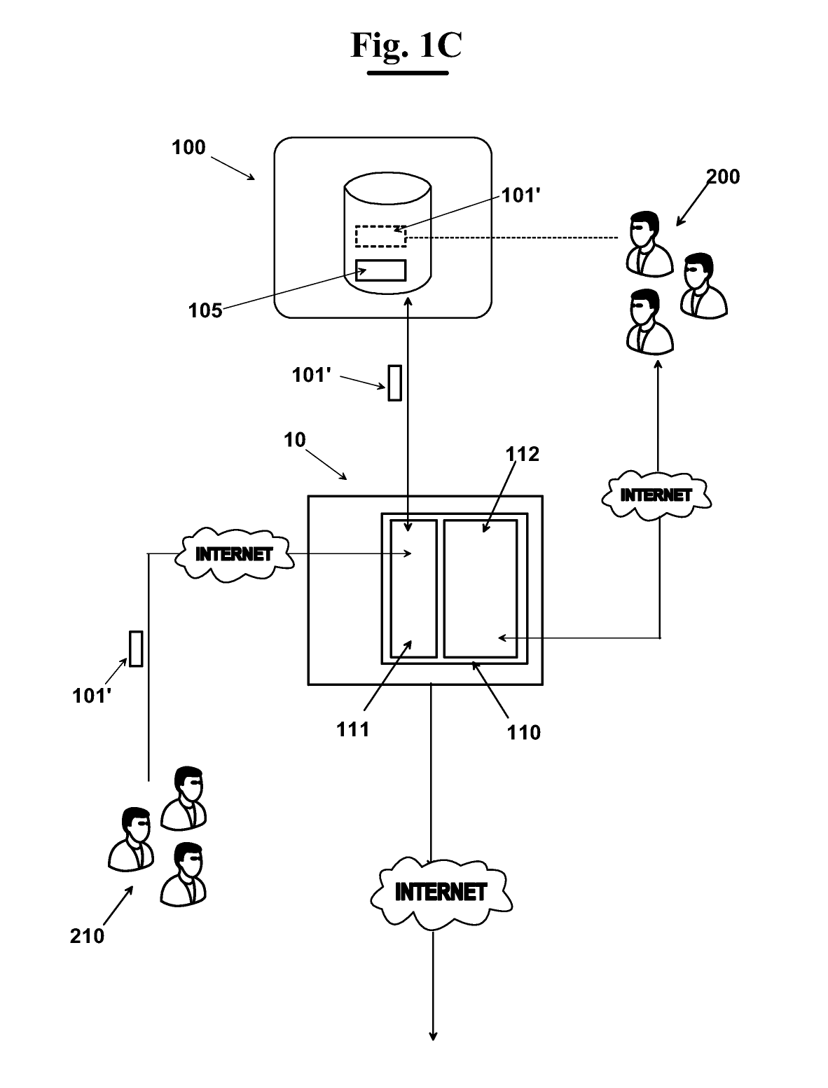

As diagrammatically shown in FIG. 1, a method for managing data concerning an event, in particular a sport event, and/or an individual, in particular an athlete, through an Internet network, provides a starting step of arranging a database 100 containing a plurality of data concerning a plurality of events and/or of individuals. Then, a step is provided of access by a user to a predetermined web page 110, i.e. associated with a predetermined URL, through which an administrator who delivers the service is interfaced with connected users.

Once connected to the above described web page 110, user 200 selects at least one desired event and/or an individual among the plurality of events and/or individuals contained in the database 100, obtaining the selection of at least one selected individual and/or event 101′. Is, furthermore, provided a central control unit 10 configured to associate each user to each individual and/or event selected 101′ by the user same. This way, it is obtained a plurality of data associated with a list of users comprising a determined number of users. Central control unit 10 provides, then, to carry out an extraction step of the associated data obtaining a plurality of extracted data 101″ and to execute a step of monitoring the extracted data 101″ for measuring possible changes the data same. More in detail, when central control unit 10 during the step of monitoring 101 detects a change 105 of the data extracted, a step takes place of sending a notification message 130 to all the users associated 200 for notifying the change 105 of the data. In this way the users associated are informed in good time of the change 105 that occurs for one, or more, of the data which they are interested to.

The notification message 130 that is sent to user 200 can be a notification message to a telephone address and/or a notification message 130 sent to a social network to which the user associated is recorded and/or a notification message 130 of e-mail. These data can be indicated by the user when registered to the service.

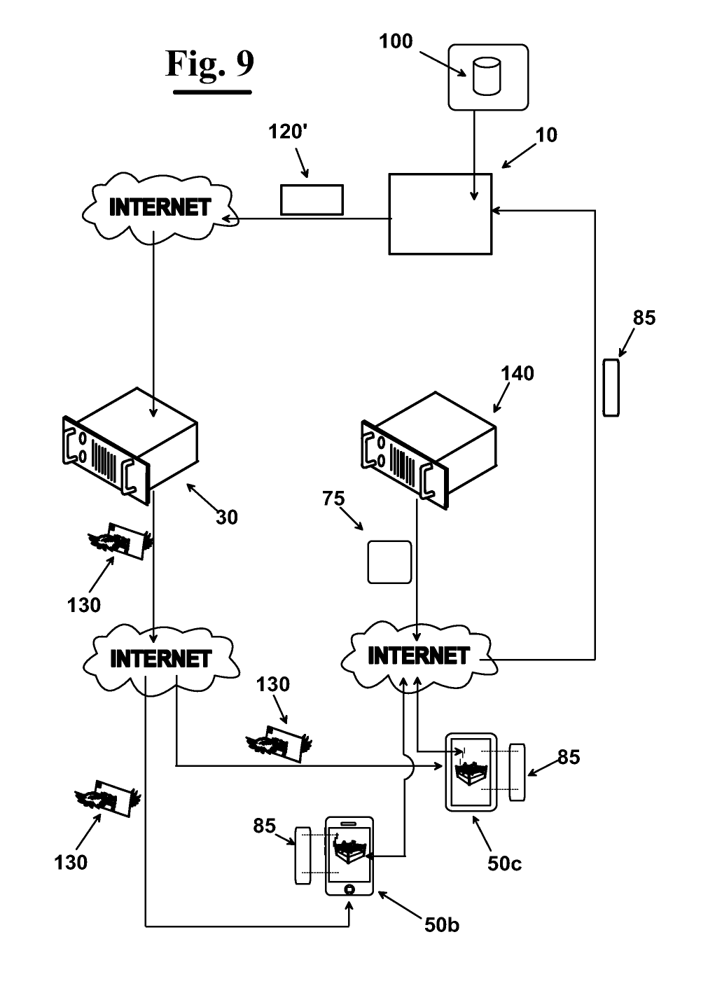

According to the invention, the notification message 130 can be sent to an electronic device with Internet access, for example a smartphone, or a tablet, using a specific procedure described in detail hereinafter with reference to FIG. 9, and that provides a notification server 30.

The method provides, then, a acquisition step of a stream of audio and/or video data 160 concerning the event and/or an event associated with the individual. Such step is made using at least one video camera 60 adapted to detect the stream of audio and/or video data 160 at a predetermined display resolution.

The stream of audio and/or video data 160 is then sent to a streaming server 70 that provides to transmit the event via streaming on a streaming channel by a live transmission streaming, or a transmission streaming on demand. Therefore, user 200′ that has been informed by the notification message 130 of the change 105 of the data concerning the desired event and/or the individual desired can connect to the streaming channel and to see the event of its interest.

The notification message 130 can be an e-mail, or a message sent on the social network indicated by the user. In this case the notification message can be sent directly by the central control unit (FIG. 1A).

In an exemplary embodiment, the notification message is sent to the user according to the procedure indicated hereafter with reference to FIG. 1, B.

At first, central control unit 10 delivers to a notification server 30 the list 120 of users associated with the above described changed extracted data, i.e. for which central control unit 10 same has detected a change 105. Then, the transmission is made from notification server 30 of a notification message 130 to the users contained in the user notification list 120, in order to notify that the desired data have changed 105. In this case the notification message 130 is sent to the telephone address indicated by the user. Such solution has the advantage that user 200′ can receive the notification message also when the application that administers the service on the telephone device, for example a smart-phone, is closed.

According to the invention, the notification message 130 can be associated with a visual and/or sound alarm, and/or a vibration of the interface device, for example of a smart-phone, or of a traditional mobile phone. This way, it the attention of user 200′ is obtained and, accordingly, there is a high probability that user 200′ is notified in real time of the change 105 of the desired.

More precisely, if the notification message 130 is sent by central control unit 10, a control step is provided that is carried out by a control program installed on the interface device 50, for example a smartphone, configured to emit a visual and/or sound alarm signal to receive the notification message 130, for example of the e-mail, or the message on the social network.

If the notification message is sent by the notification server according to the above described procedure, instead, it is the telephone device of the user, for example the smartphone, which emits the sound signal for example a “beep”, or a visual signal, for example a “pop up” message already provided in the telephone device, and/or a vibration.

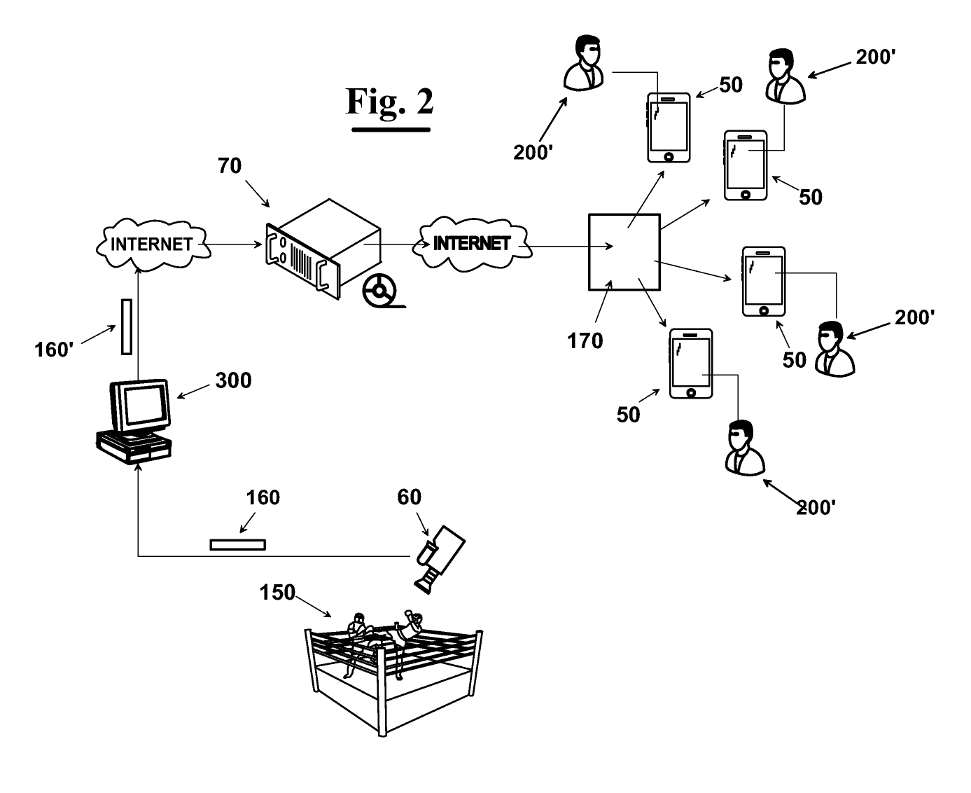

Preferably, as diagrammatically shown in FIG. 2, the stream of audio and/or video data 160 acquired by the video camera 60 before sending to the streaming server 70 passes through a program means 300 on which a data control program is running. In particular the program means 300 are configured to analyze the stream of audio and/or video data 160 acquired and to compute it. The stream of computed audio and/or video data 160′ is, then, sent via web to said streaming server 70.

The above described program means 300 are, in particular, adapted to compress the stream of audio and/or video data 160 for adjusting the resolution of the stream 160 same. More precisely, the program means 300 are adapted to compress the resolution of the stream of audio and/or video data 160 from an acquisition resolution to a final resolution on the basis of a plurality of predetermined parameters. The parameters that are considered by the program means 300 for determining what is the final resolution 160′ of the stream of audio and/or video data correspond to a value of interest given to the event 150 and/or to at least one individual that is involved with the event 150. For example, in the case of a sport competition, such as a match of a championship, a lower value of interest can be given initially to the event, if this is a first round of a tournament, and a higher value of interest in the successive phases, i.e. eighth-finals, quarter-finals, semifinals and final. Furthermore, each team of the tournament can be associated with a rank value responsive to the position at which it is classed, e.g. international ranking, etc. Therefore, the program means 300 for computing all the values of the parameters involved will give an overall value to each event 150 to compute the quality of the stream of audio and/or video data 160 for compressing them to obtain a final stream of data 160′ at a corresponding resolution.

Another possible parameter that can be considered by the program means 300 for determining the final resolution of the stream of audio and/or video data 160′ can be the number of users 200′ to which the event has been notified, or the number of users connected to the streaming channel 170 that transmits the event. In line of principle, in any case, the higher is the overall value of these parameters, the higher is the resolution of the final stream of audio and/or video data 160′ transmitted by the streaming server 70.

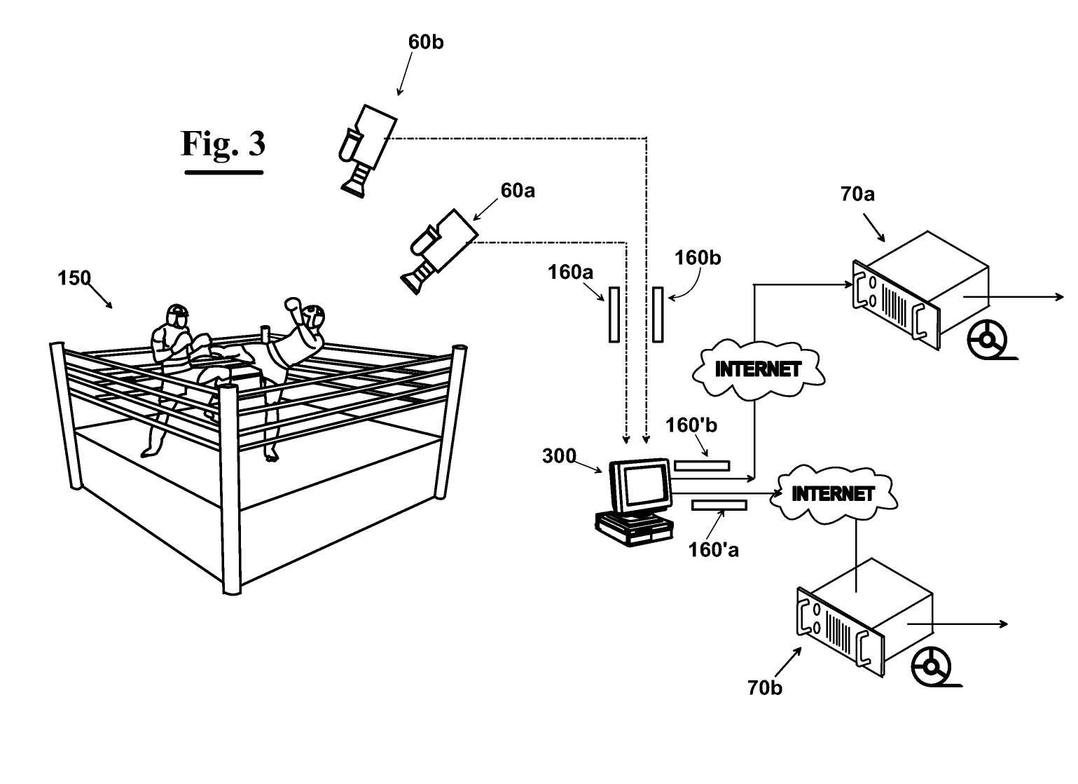

As diagrammatically shown in FIG. 3, the method, according to the invention, can provide the use of a plurality of video cameras, for example at least one first video camera 60a and at least one second video camera 60b. Each video camera 60a, 60b is adapted to detect a respective stream of audio and/or video data, 160a, 160b, concerning the sport event 150, for example a match of Muay Thai. In this case, the program means 300 can be configured to analyse the streams of data 160a, 160b, having a predetermined display resolution obtaining a plurality of streams of audio and/or video data 160′a, 160′b having respective degrees of display resolution. The program means 300 can be then adapted to select among the different computed streams of audio and/or video data 160′a, 160′b that are associated with a determined resolution that is sent to a streaming server 70.

The program means 300 can also be configured to send each stream of computed audio and/or video data 160′a, 160′b to a corresponding streaming server 70a, 70b each of which is configured to transmit the event on a determined streaming channel 170. According to the type of subscription of the user, or other criteria, the user will be enabled, then, to connect to one of the streaming channels that transmit the event 150 and to see the event at the corresponding resolution.

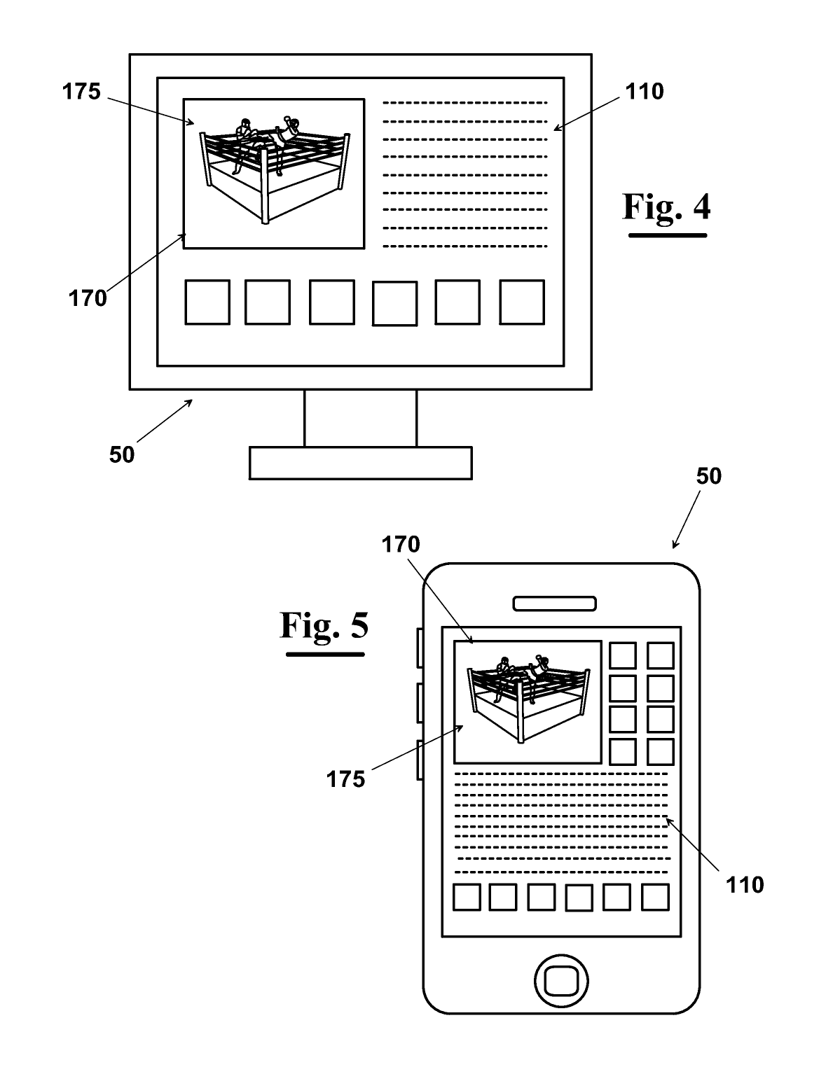

According to an advantageous exemplary embodiment of the invention and diagrammatically shown in FIGS. 4 and 5, the streaming channel 170 can be integrated in the above described web page 110 through which the service is provided. More in detail, in the above described web page 110 a window 175 is displayed of a predetermined size connected to the streaming channel 70 that transmits the event 150. This way, user 200 can watch the desired event 150 through the above described web page 110 in a way extremely easy and safe, and without the need to search the streaming channel 170 that transmits the event.

Before the above described step of selection by the user of at least one desired event and/or an individual preliminary steps can be provided of subscription by user 200 through the predetermined web page 110 to the streaming service. More in detail, the step of subscription comprises a step of input of personal data of the user, among which the access identification data i.e., a user name, or user ID, and an alphanumeric authentication code, or password, and at least one among a telephone address, an e-mail address, an indication of a social network to which the user belongs. The latter user data are by the central control unit for sending the notification message according to the above described mode.

Instead, the access identification data are inputted by the user for executing a login and approaching a reserved area of web page 110 in which the streaming channel 170 that transmits the event can be selected.

As diagrammatically shown in FIG. 1C, a step can be provided of introducing a data value, or of changing at least one value, 101′ by one, administrator 210, or more. More precisely, the administrator 210 is adapted to put the update, and then the change of the data value, through a back-office interface 111 of web page 110 to which the administrator 210 is connected via Internet. Therefore a change of the data 101 is caused obtaining the changed data 101′ that triggers the step of sending the notification message as described above.

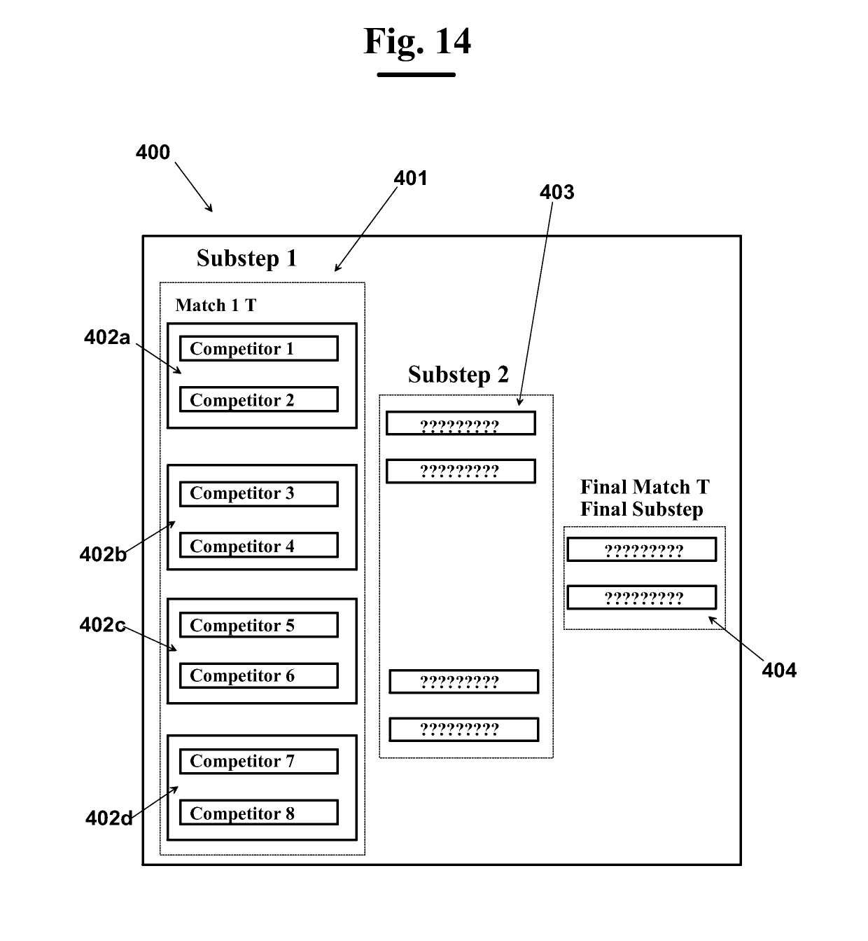

The input by the administrator 210 can provide, for example, the introduction of an event in the database 100 and indicate at least one time value, in particular a data and/or a time of the event. The event can be selected from the group consisting of: a single match, a plurality of matches, a plurality of matches arranged as a bracket, a plurality of matches arranged at tournament, or a combination thereof as described in detail hereinafter with reference to FIG. 14 to the 17.

Once created the event, the change of the data can be made, for example, by the subscription to said event by an individual and/or of an organization to which at least one user 200 is interested.

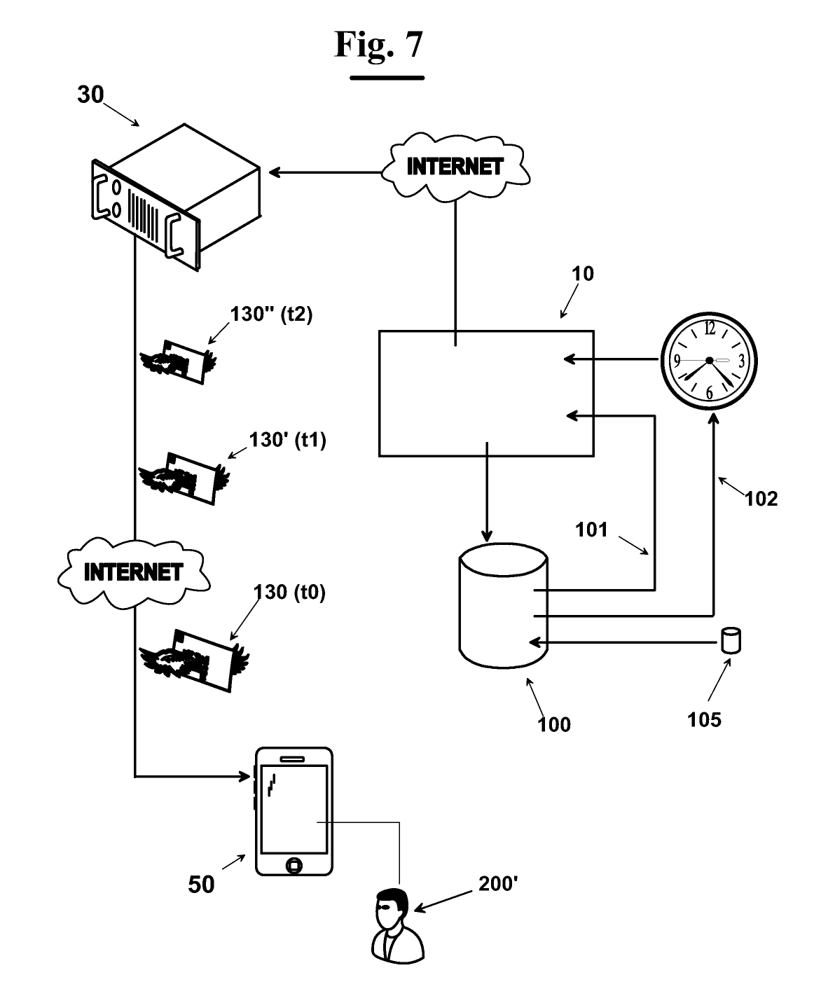

In a possible exemplary embodiment shown in FIG. 7, central control unit 10, when a change 105 of the data concerning the event and/or the individual is found, is configured to start a countdown 101 of the waiting time for the event 150. In this case, an operation of sending the notification message 130 to the users 200 of the list and/or the list of users 120 to notification server 30, is effected by central control unit 10 when the waiting time to the event, or associated with the individual, is less than a predetermined threshold time t*.

In a possible exemplary embodiment, central control unit 10, when the waiting time t to the event is less than threshold value t*, is configured to send a plurality of notification messages 130 at predetermined time intervals, i.e. a first notification message 130 to a starting time tₒ, a second message 130′ after a predetermined time t₁ after the first message, a third message 130″ after a predetermined time t₂ after the second message and so on, up to the beginning of the event 150.

In an exemplary embodiment, the operation of sending the notification message and/or the user notification list to the notification server is effected by a central control server when an administrator previously authorized to enter changes to the data contained in said database, enters manually a change 105 of said data through said interface web page 110.

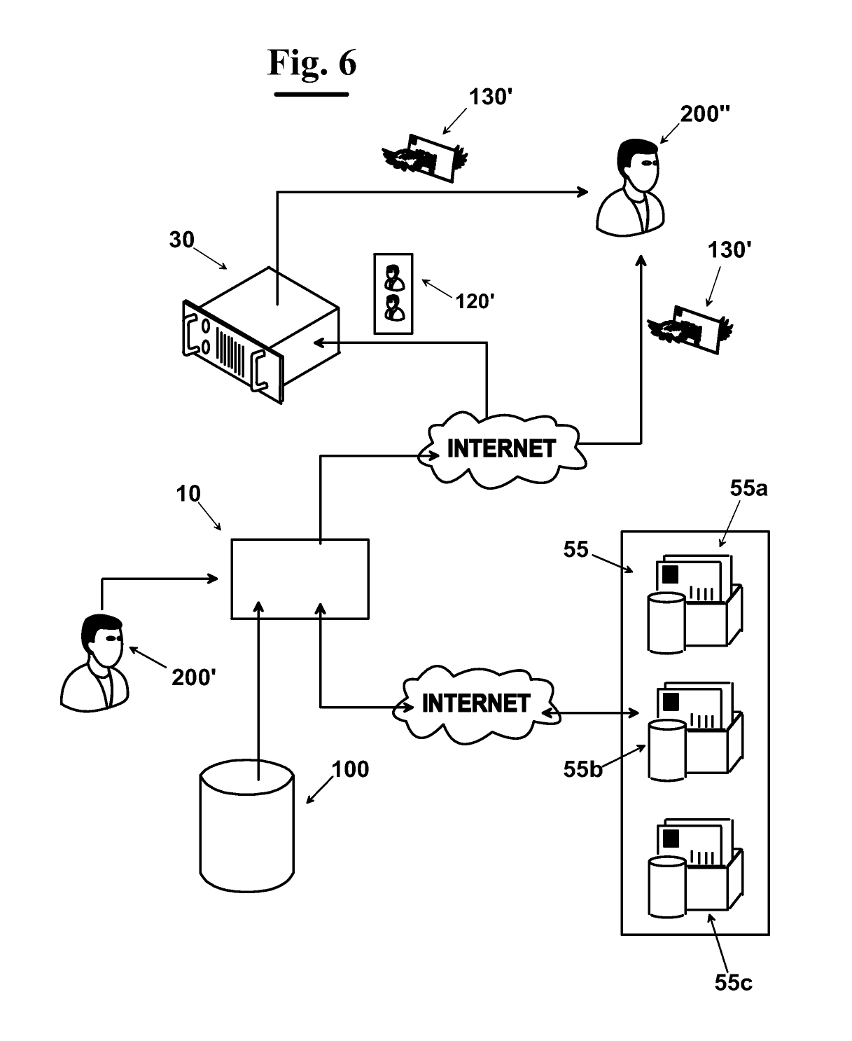

As shown in FIG. 6, it can be also provided that central control unit 10, after acceptance by the users who have subscribed the service, carries out a step of accessing the contact book 55 of a user 200′ associated with the changed data and of sending an additional notification message 130′ to at least one contact of the contact book 55, in order to inform also a user 200″ about the change 105 occurred in the monitored data. The contact book 55 of user 200′ from which the, or each, contact can be extracted can be the contact book 55a of the telephone device of the user and/or the contact book 55b of the social network to which user 200′ is enrolled and/or the contact book 55c of the e-mail address of the user. Even in this step, central control unit 10 and/or electronic device 50 with Internet access can send directly the additional notification message 130′ to contact 200″, for example sending an e-mail, or a message to the social network, and/or involve a notification server 30. In the latter case, central control unit 10 delivers reference data 120′ of the contact extracted from the contact book 55 of the user to notification server 30. This permits, then, to send an additional notification message 130′ to the contact extracted from the contact book 55 of user 200′, in order to inform also contact 200″ of the occurred change 105 of the data in which user 200′ is interested.

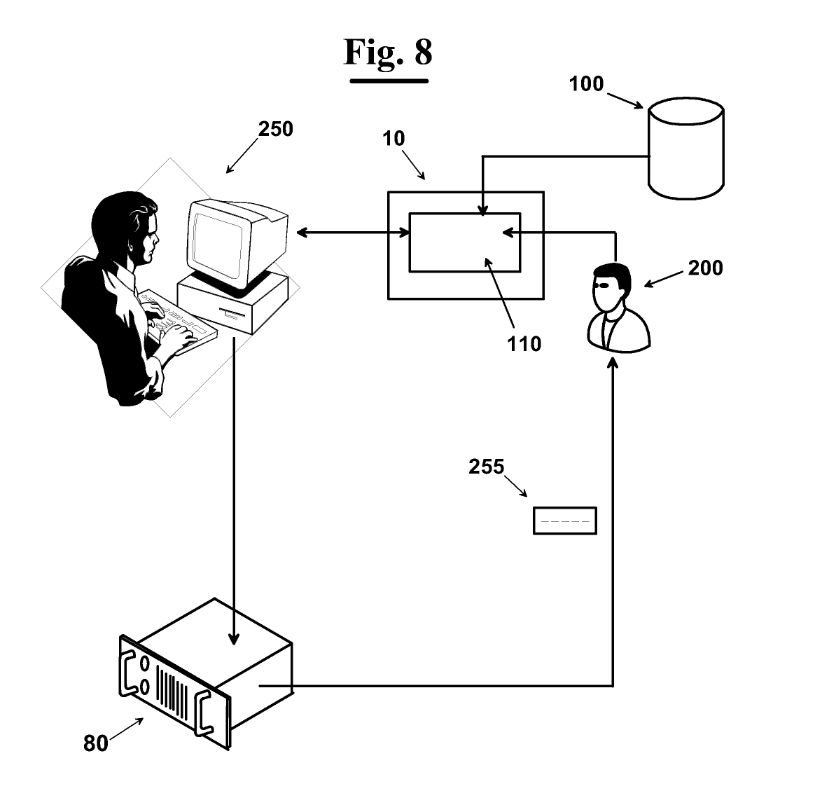

According to a particular aspect of the invention and diagrammatically shown in FIG. 8, each area of web page 110 dedicated to an event, and/or to an individual of the database 100, can comprise a graphical sign, for example an icon, associated with one sponsor 250, or more, that participate to this data management service. Therefore, user 200 can select, through the reserved area of web page 110, at least one icon. At the selection of the user of the icon, central control unit 10 delivers a discount code 255 to user 200. The latter can enter the discount code 255 in a special interface area of web page 110, or the web page of the sponsor dedicated to the e-commerce, in order to profit of a discount on the purchase price. It can be, in any case, also provided that the discount code is shown by user 200 at a sales point indicated by the sponsor 250 where user 200 can physically purchase personally the product. In both cases, at least one part of the discount accorded to user 200 is shared between a service manager and the individual through the page where the user selected the icon.

In FIG. 9, the procedure of sending the notification message 130 is diagrammatically shown, through a notification server 30, to a smartphone 50b, or a tablet 50c, associated with a unique identification code 85. In this case, a step is provided where smartphone 50b, or tablet 50c, is connected via Internet to a download server 140. Then, a download step of a predetermined application program 75 is started by download server 140 towards smartphone 50b, or to tablet 50c. Once installed on smartphone 50b, or on tablet 50c of the user, application program 75 provides to measure the unique identification code 85 of the device 50 and to transmit it to central control unit 10. Central control unit 10 provides then to associate the unique identification code 85 to the data of the user who owns smartphone 50b, or tablet 50c. Therefore, when central control unit 10 detects a change of the data monitored provides to send to the notification server 10 a list of users to which notify the data, or more precisely a list of unique identification codes associated with the users in turn associated with the event and/or athlete and/or organization.

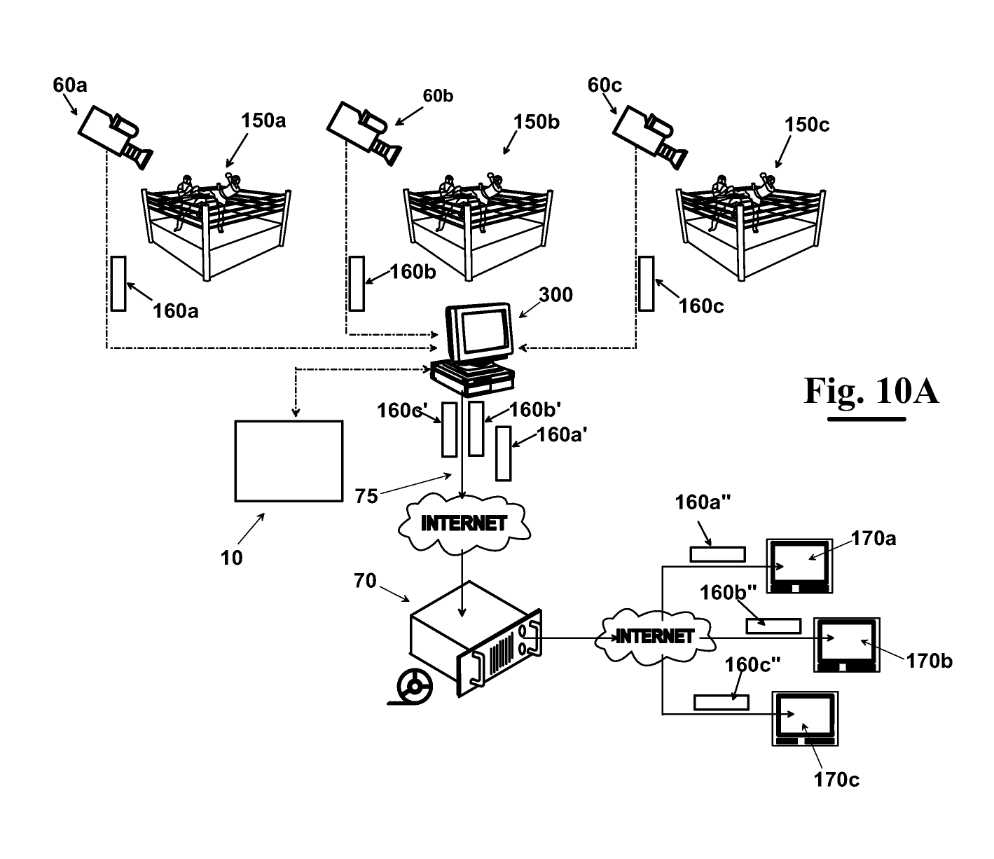

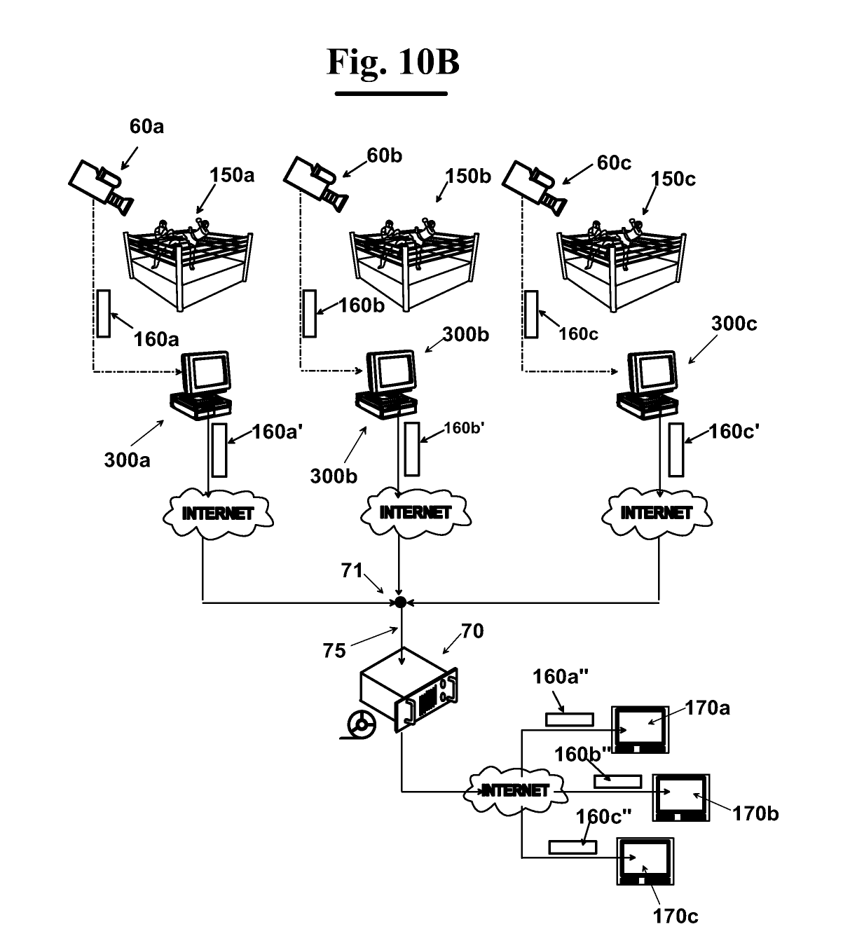

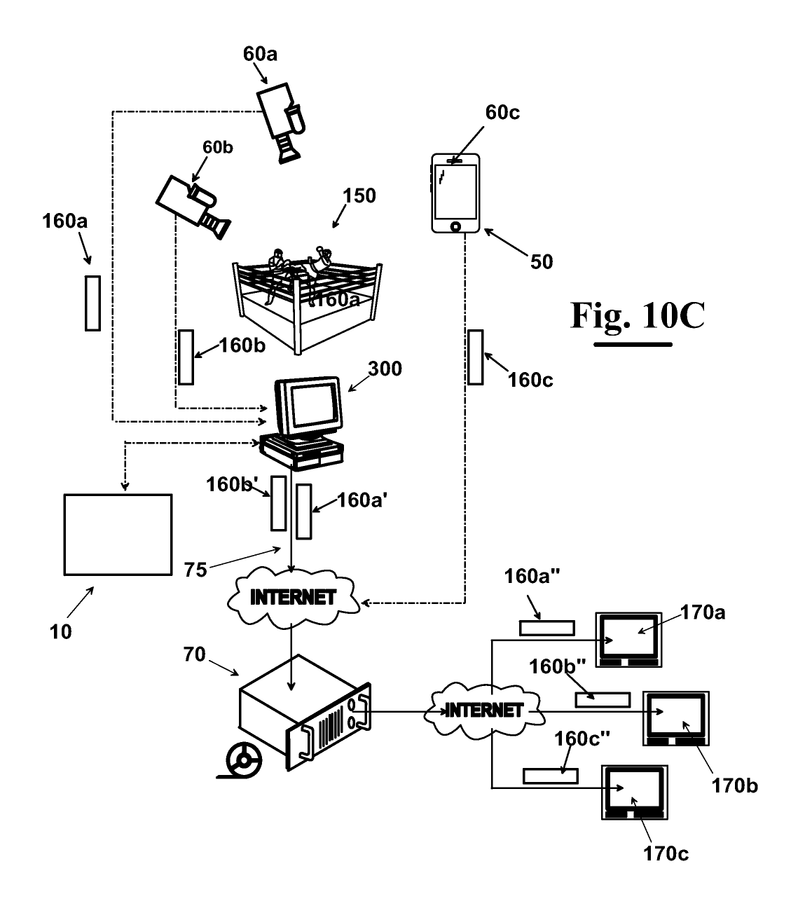

According to what provided by a particular aspect of the invention, as shown in FIGS. 10A and 10B, the acquisition step can provide a contemporaneous acquisition of a plurality of events, for example three events 150a-150c through a plurality of video cameras, for example three video cameras 60a-60c. More precisely, each video camera 60a-60c of the above described plurality is adapted to detect a respective stream of audio and/or video data 160a-160c having a determined display resolution and then a determined size, normally expressed in kbps, and concerning a respective event 150a-150c.

The above described streams of audio and/or video data 160a-160c are computed by a program means, for example a single computer 300 (FIG. 10A), or a computer 300a-300c for each stream of data 160a-160c acquired (FIG. 10B).

More in detail, the program means 300, or 300a-300c, are adapted to compress at least one stream of data of the above described plurality 160a-160c, if the size overall of the streams of audio and/or video data is larger than the size of the band 75 used for sending the above described streams of audio and/or video data 160a-160c to the streaming server 70. In particular, 75 in case of more program means 300a-300c, the relevant band is comprised between node 71, located upstream from server 70, at which the many streams 160a-160c converge, and the streaming server 70.

The streaming server 70 provides then to transmit each stream of audio and/or video data 160a-160c of the computed plurality of streams, to respective streaming channels 170a-170c. The latter can transmit the event via streaming at a predetermined display resolution, or to a determined resolution on the basis of a plurality of predetermined parameters. For example, the parameters considered for determining such as resolution for a streaming transmission of the event, or broadcasting, can be selected from the group consisting of: the number of users that have indicated an interest for the event, or for an athlete, or a team, or a sporting federation, or other organization, which is involved with the event. Other parameters that can be considered for determining the display resolution to which transmitting the event in streaming are the number of users connected to the channel during the transmission. Another parameter that can be considered for determining if and at which resolution transmitting in streaming an event can be the number of registered users, or associated with an individual and/or an event and/or an organization, in a determined geographic area. Therefore, in this case, when subscribing the service the user indicates to the service the personal geographic area.

In the example of FIG. 10C, the acquisition step is effected through a plurality of video cameras, for example three video cameras 60a-60c, each of which is adapted to take a stream of audio and/or video data 160a-160c concerning a same event 150 at a respective predetermined display resolution, or dimension. At least one of the above described video cameras, for example the video camera 10C, can be provided integrated in an electronic device 50 with Internet access, for example a smartphone, or a tablet.

The streams of audio and/or video data 160a-160c are, then, sent to the streaming server 70, directly in the case of a smartphone, or tablet 50, or through a program means 300 externally connected to an Internet network, in case of “traditional” video cameras, i.e. not having an direct access to the Internet.

In particular the streaming server 70 can be configured to select at least one stream of audio and/or video data of said plurality on the basis of said display resolution, or dimension, and to transmit the selected stream of audio and/or video data to a respective streaming channel. In the case shown in FIG. 10C, more streaming channels are provided, and precisely three streaming channels 170a-170c each of which adapted to transmit the event at a predetermined display resolution.

It can be in any case provided the possibility of transmitting only one stream of the above described acquired plurality of streams audio and/or video data 160a-160c. More precisely, the streaming server 70, or program means, can select a single stream of data among the acquired different streams and transmit only it through the transmission channel. In addition, or alternatively, the streams can be computed for being compressed responsive to the size of the band, or of other parameters, such as number of users associated with the event.

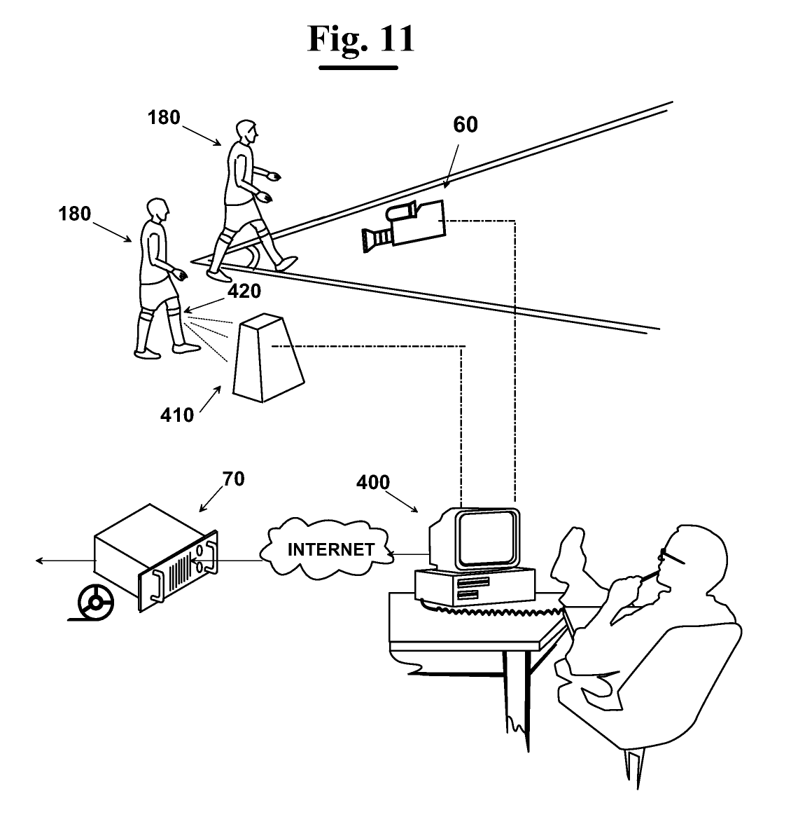

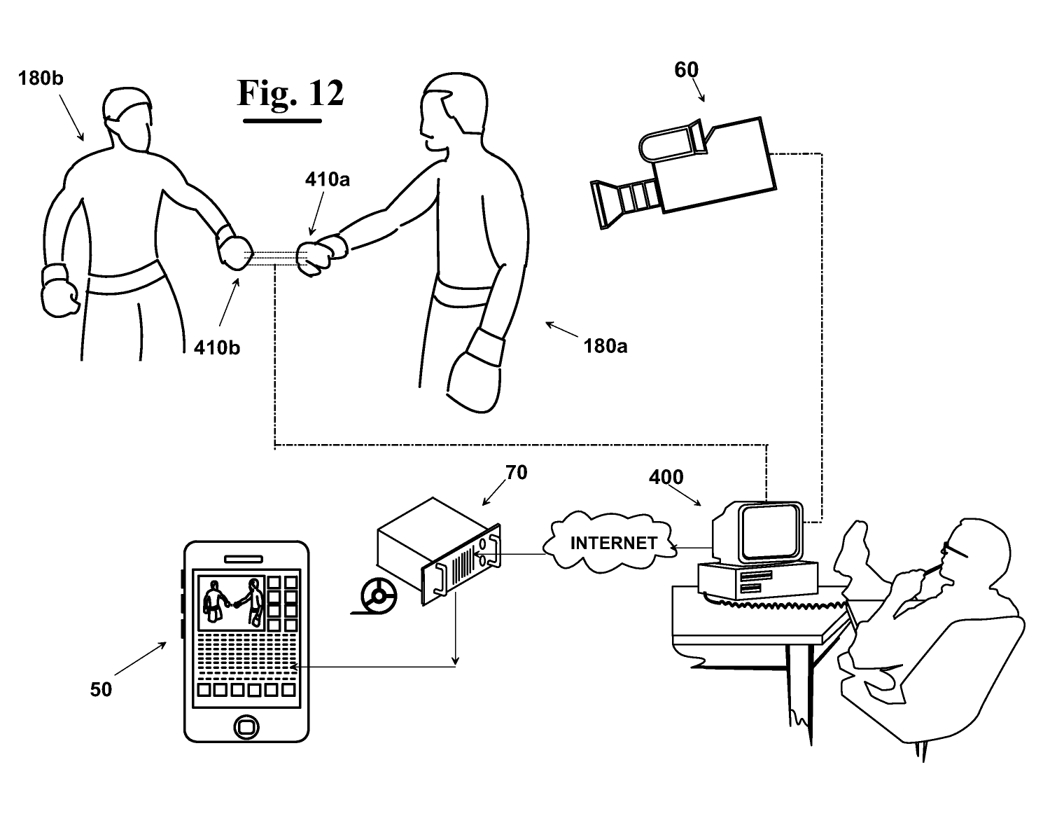

As diagrammatically shown in FIGS. 11 and 12, the method can provide the use of an activation system configured for triggering the streaming server 70 to start the transmission of the event at determined circumstances.

For example, the activation system can provide at least one device 410 associated with an identification code, for example a bar code, and a reading device 420 adapted to read the identification code and to transmit it to a control means 400. An identification verification procedure, for comparing the identification code 410 with a predetermined code can be provided. If this comparison gives a positive result, the control means 400 is configured for triggering the streaming server 70 that therefore starts the transmission of the event 150 through the streaming channel. In case of negative result the streaming server 70 is not activated. Normally the reading device of the identification element can communicate by a radio transmission, or an infrared transmission, or other known technology, such as Bluetooth transmission, or wifi, or by means a wired transmission, for example by means of USB ports.

In an exemplary embodiment, the activation system provides the “Radio Frequency IDentification”, technology or the RFID. In this case, at least one RFID tag is provided, for example installed on a garment, such as a sock, or a bracelet, or on shots, of at least one individual 180 participating to the event. When the individual 180, for example the athlete, passes at a reading device 420, the read identification code is sent to the program means 400 that starts the above described verification procedure.

In another exemplary embodiment, as shown in FIG. 11, the activation system provides the NFC technology, i.e. “Near Field Communication”. More precisely, the use provides a first device 410a, or “initiator”, installed on a garment, or an accessory, worn by a first individual 180a that is involved with the event, for example a first athlete, and a second device 410b, or “Target”, installed on a garment, or accessory, worn by a second individual 180b that is involved with the event, for example a second athlete. When the first and the second device 410a and 410b are arranged within a predetermined distance, for example between 2 and 10 cm, among which a peer-to-peer communication is created and both can send and receive data. This way, when the two devices 410a and 410b are arranged within the above described predetermined distance it is possible to test the identity of the individuals and, in case of correspondence with predetermined data, there a signal of activation to the streaming server 70 is sent that starts the transmission of the event.

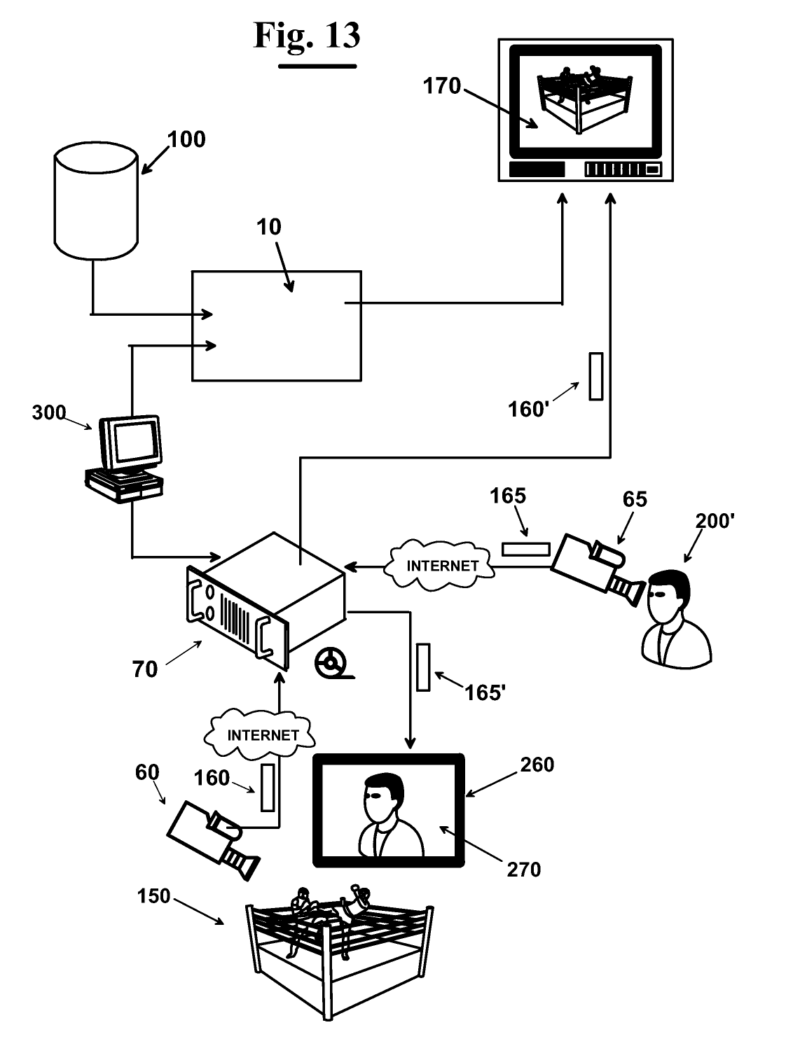

As shown in FIG. 13, a further exemplary embodiment provides the possibility of detecting an additional stream of audio and/or video data 165 by an auxiliary video camera 65 adapted to point to the person associated with the event and/or to the individual and/or to the organization. Once acquired the additional stream 165 there the additional stream of audio and/or video data 165 is sent to a predetermined streaming server, for example the same streaming server 70 through which the stream of audio and/or video data 160 of the event 150 is transmitted. The streaming server 70 provides then to transmit the stream of additional audio and/or video data through a streaming channel, for example integrated in a display device, or monitor 260, arranged near the event and in which an additional streaming channel 270 is integrated. This allows the users 120 to participate to the event 150 and to interact with the individual, or the team, in order to establish dialogue with them, or simply for urging the athlete, or the team.

In FIG. 14 to the 17, some examples of events created by administrators according to the present method are diagrammatically shown.

Normally, an event can be created by the administrator in the web page, both in the case of a single match, which in the case of a championship, or a tournament, and comprises then a predetermined number of matches.

In the case of an event comprising a predetermined number of matches, the method provides splitting the event same into a predetermined number of levels. In particular an event can be arranged as a championship and providing determined rules according to which a team, or athlete, passes from a round to a successive, or as a bracket tournament in which two competitors compete a predetermined number of times for example a sudden-death tournament, or at best of three, or five matches, up to determining the winner of the bracket and passes to the next level, or round.

In the example of FIG. 14, there is a first phase, block 401, of a competition 400, shown as a homogeneous structure of matches, for example four matches, blocks 402a-402d. According to the result of the matches in the phase 1, block 401, to the successive level, or phase 2, block 403, at least one individual, or competitor, of the individuals, or first competitors, block 403, are admitted. In the example of FIG. 14, to the initial phase, block 401, 8 competitors participate, and to phase 2, block 403, 4 competitors participate, i.e. the teams, or athletes that have won against the respective competitors in phase 1 and passed then to the next level.

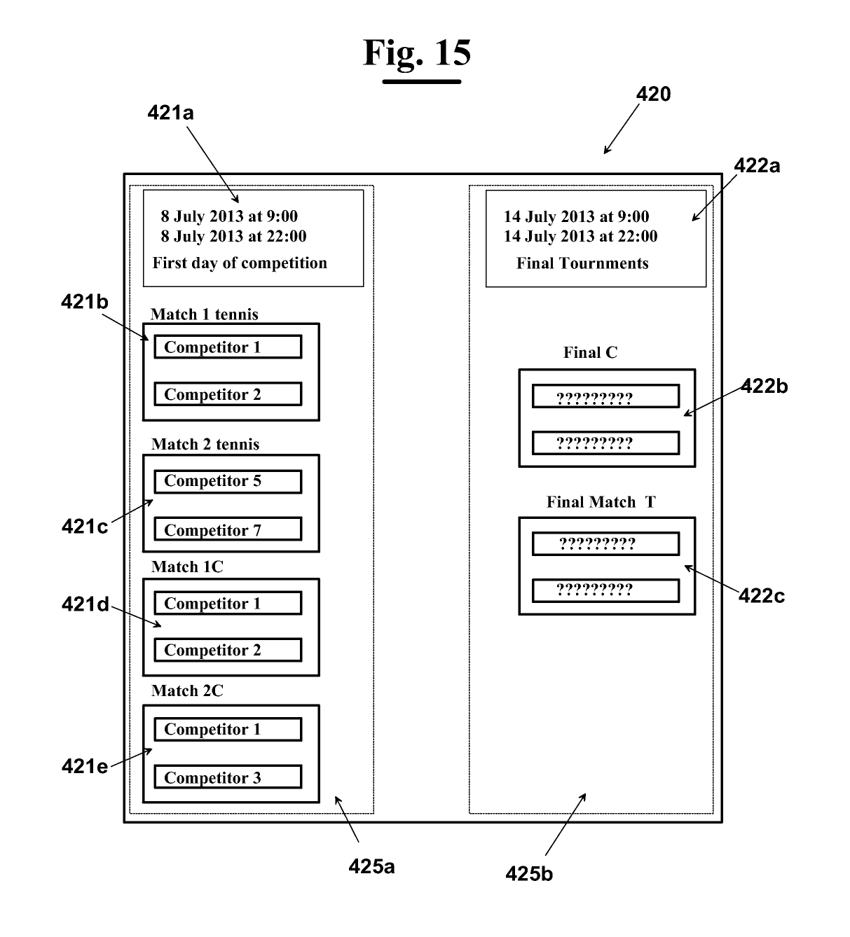

As shown in FIG. 15, a phase 425a, or 425b, is a subset of matches that is used for defining at which stage the tournament, or the championship, is. For example, a soccer championship, “first leg” and “second leg” are two phases.

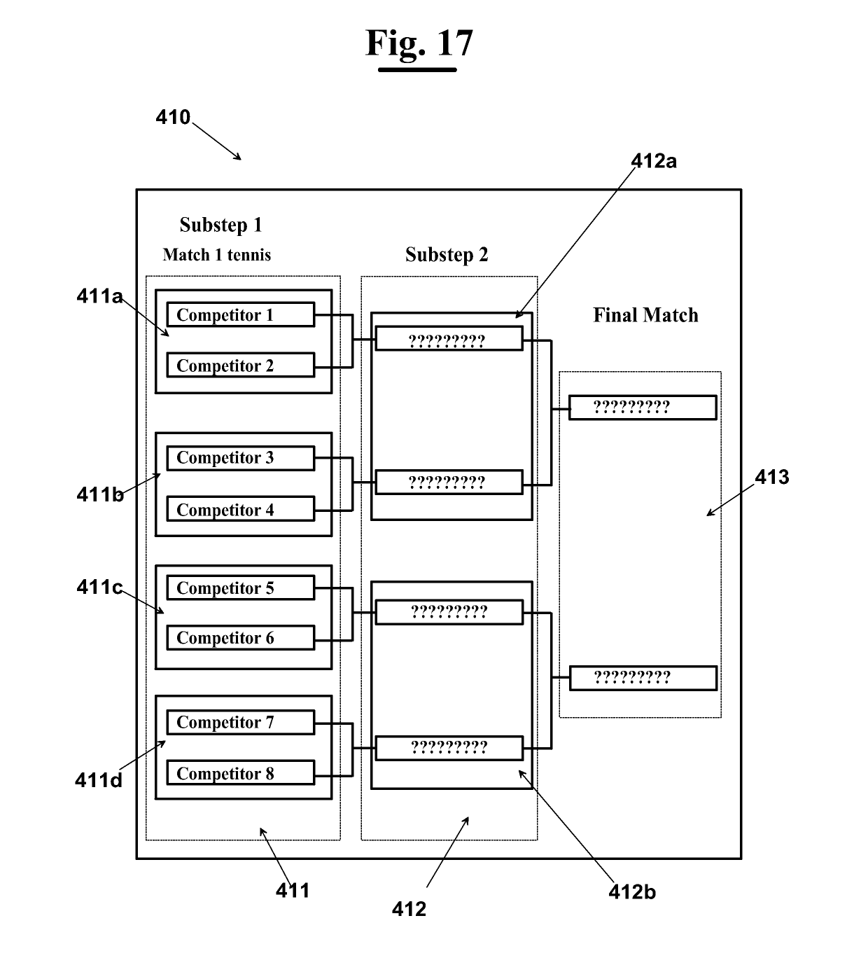

In case of a bracket tournament, for example shown in FIG. 17, like a tennis tournament, the phases can be considered as the matches 411a-411d that bring to the direct elimination of the team, or the athlete. The tournament comprises a single step 410 comprising 3 phase 411-413, i.e. quarter-finals, block 411, semifinals, block 412, and final, block 413.

For passing from a phase to a ext one, for example from phase 411 to phase 412, it is necessary to play a set of one, or more matches 411a-411d. For determining the winner of each phase, or of each match, it is necessary to establish determined rules, which are defined referred to each competition, and that are applied to each match for determining its result.

The method, according to the present invention, provides also the possibility of organizing an event that for example provides one, or more rounds, and at least one sudden-death tournament. In order to understand better the Soccer Champion's League can be considered as example. In this case, from the eighth-finals to the quarter-finals, a single match between the two teams is not enough, but it is necessary to play a first leg and a second leg and determine the winner according to predetermined rules, for example the validity of the goals in case of tie according to which team is the home team in each leg. In case of tennis tournaments, instead, usually a phase is composed by a single match of the bracket.

If a match is among more teams, or athletes, a ranking is determined. For example in a soccer match one of the two teams wins or the match finishes in a tie. If the match is, for example, a swimming race where the athletes are more than two, the result of a match can be in any case, generally a classification of teams.

First Stage

More phases are provided of “round Robin” type. Each round comprises more teams, for example 4 teams, which compete with each other. From each phase or “round” 2 teams pass that participate to the next phase arranged as brackets.

Second Stage

The second stage is arranged as brackets and starts from the eighth-finals. From a phase to the next, the teams compete in a plurality of matches like “first and second leg”. The specific rules for passing the phase is determined by the total of the goals made and in case it finishes in a tie the goals made by the home team have a different weight, because the goals made by the other team have double value.

On the basis of the above structure, in the back-office interface the administrator will combine the stages, phases, brackets and rules for determining the winner by fixing the features of the tournament.

In a bracket a determined number of matches between two team, or athletes, is needed, for example a single match, best of three, best of five, etc.
In the back-office interface the administrator of the event provides also the features of the tournament that can be, for example selected from the group consisting of:
Kind of subscription: “open” if any Team can subscribe the tournament, “upon invitation” if a Team has to be invited to the tournament;
Name of the tournament: a string text that describes the name;
Logo of the tournament: an image that represents the tournament;
Description of the tournament: a description of what is the tournament;
Title: The prize for the winner of the tournament, in particular the title is established by the organizations, or federations;
State of publication: if the tournament is published visible to all on the public of the system in a web page, or even in phase of construction.

An event can be described by one, or more of the following data:
title of the event: a title describing of the event
description of the event: a description of what is the event
initial date: date in which the event starts;
end date: date of conclusion of the event;
logo of the event: name of the event;
Match/Phases/Competitions: a set of matches, steps, Competitions with a day and a time of the event, blocks 421a and 422b of FIG. 15.

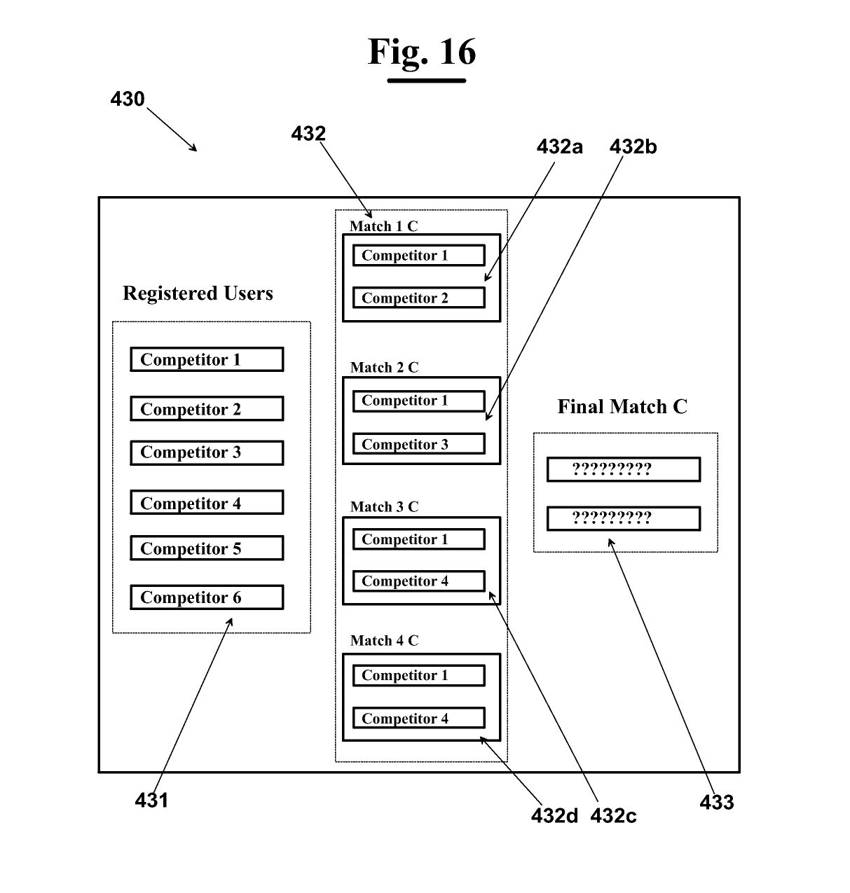

In FIG. 15 a tournament of tennis is diagrammatically shown, for example a tournament of tennis in an Olympic competition, whereas in FIG. 16 a tournament of soccer of the same Olympic competition is diagrammatically shown.

With reference to FIGS. 1 and 6, an administrator 210 can organize a tournament, for example a tournament of soccer 430, entering the number of teams that can participate to the event and the template of the matches configured as events in addition to the rules adopted for moving from a level to a successive level. For example, championship can be a round Robin with 6 teams, or competitors 1-6. The end users who subscribed the service can select the tournament up a maximum number available. Then, the event is updated with the data relative to the team, or to athletes, participating to the event. Therefore, the central operating unit 10 that detects such changes will start the procedure of sending the notification messages to all the users interested to the event and/or to a team participating to the event and/or to an athlete that is involved with the event.

The event can also comprise more matches, for example, a single-elimination tennis tournament with 8 participants to elimination direct and a soccer championship.

Hereinafter the procedure through which it is possible to enter the many matches in a competition is diagrammatically shown according to the method for managing data according to the present invention.

In a first step, if acting as administrator, a user can create the soccer tournament template. The user creates then a first round, e.g. a Round-robin, and the rules are generated for determining which team can pass the first round and go to the next round. The second round, for example, can be a single-elimination round between the first two classified of a previous round, e.g. the same initial round, or different rounds. The winning team wins the whole tournament. 6 teams are, for example, entered the first round and the system creates automatically all the matches.

The administrator creates also the tennis tournament template, in particular, a bracket is created as shown in FIG. 17. Then 8 athletes are entered, or competitors, for example with the indication of the seeded players, and the system generates in automatic the first 4 matches with athletes assigned according to predetermined rules, whereas the following rounds of the bracket will be empty waiting for the results of the previous matches of the tournament.

At this point the template of the event is created, for example “Summer Olympic games 2013”. In the description field, for example, “the first Summer Olympic games, do not miss it”, is indicated, and then date of beginning the whole competition, for example 8 Jul. 2013 and the date when the competition ends, for example 14 Jul. 2013 and preferably the respective beginning and end time.

If in the first day there are two matches of soccer and two of tennis, by an user-friendly interface a list of matches is displayed, and the two matches of the soccer tournament are selected, as well as the two tennis matches, that are put in the event indicating a date and time of start for each match.

For acquisition and transmitting via streaming the matches, the administrator 210 creates by the back-office interface 2 a match location, one for the soccer match and one for the tennis match and assigns a channel 1 to the former and to a channel 2 to the latter.

When acquisition the video, by the application of a streaming device installed on the PC, the administrator 210 delivers the streaming on the channel 170 corresponding to the location of the match 150. The users 200, or fans, having access to web page 100 that provides the streaming channel 170, can follow the event via streaming.

It can be also provided that the users who subscribed the service can make bets on the match. A bet can be made through a virtual score by virtual points. In each match a coordinate is displayed at which a team, or an athlete, is found. Such coordinate can be entered in a way completely manual by the administrator of the match or calculated automatically by the system on the basis of the bets made by a better. At the moment of the subscription to the service, to each recorded user a certain an amount of virtual points is assigned by default. If all the points are lost, it is possible to recover them inviting new betters the system. The betting system can become viral increasing further the number of users. The bets of the betters is only and exemplifying way to increase the number of participants to the method according to the present invention and arrive at a viral system.

At predetermined intervals, a classification of the best better and a prize is given to them.

A classification, or ranking, can be also provided for each team, or athlete. The classification, or ranking, can be referred to a determined territory.

It is noted the term event refers both to the case where more individuals, for example two, or two teams, or more teams, make a match in a place, or field, and to the case where the individuals that participate to the event are in different places and are in communication via Internet through the service operated by the method according to the present invention, like it occurs for online games.

The foregoing description of specific exemplary embodiments will so fully reveal the invention according to the conceptual point of view, so that others, by applying current knowledge, will be able to modify and/or adapt in various applications the specific exemplary embodiments without further research and without parting from the invention, and, accordingly, it is meant that such adaptations and modifications will have to be considered as equivalent to the specific embodiments. The means and the materials to realise the different functions described herein could have a different nature without, for this reason, departing from the field of the invention. It is to be understood that the phraseology or terminology that is employed herein is for the purpose of description and not of limitation.

1. Method for managing data concerning an event, in particular a sport event and/or an individual, in particular an athlete, and/or an organization, in particular a sporting federation, through an Internet network, said method comprising the steps of:
prearranging a database, said database limiting a plurality of data concerning a plurality of events and/or of individuals and/or of organizations;
accessing by a user to a predetermined web page, said access occurring by an interface device connected to the Internet network, and indication by said user of at least one value operators selected from the group consisting of:
a telephone address;
a social network to which said user belongs;
an e-mail address;
selection by said user, of at least one desired event and/or an individual and/or an organization among said plurality of events and/or individuals and/or organizations contained in said database obtaining an event and/or individual and/or an organization selected;
associating said user, by a central control unit, with said, or each, selected event and/or individual and/or organization;
extracting, by said central control unit, the data contained in said database and concerning said selected event and/or individual and/or organization obtaining a plurality of extracted data;
monitoring, by said central control unit, said extracted data;
changing at least one extracted value of said plurality of extracted data obtaining at least one changed extracted value;
detecting said change by said central control unit during said step of monitoring and sending a notification message to said user associated with said, or each, changed extracted value, such that said user associated with said, or each, changed extracted value is informed in good time of said change, said notification message selected from the group consisting of:
a notification message to said telephone address;
a notification message to said social network to which said user belongs;
a notification message to said e-mail address;
a notification message to a smartphone, or a tablet, of said user through a notification server;
a combination thereof;
acquisition at least one stream of audio and/or video data concerning said event and/or an event and/or an organization associated with said selected individual, said acquisition step carried out by at least one video camera at a predetermined display resolution;
sending said, or each, stream of audio and/or video data to a predetermined streaming server;
transmitting said, or each, stream of audio and/or video data concerning said, or each, event from said streaming server via at least one streaming channel.

2. Method, according to claim 1, wherein if said notification message is sent through a notification server the steps are provided of:
connecting via Internet an electronic device with Internet access of said user to a download server, said electronic device with Internet access being associated with a unique identification code;
downloading a predetermined application program by said download server to said electronic device of said user;
installing said application program on said electronic device of said user;
detecting said unique identification code by said application program;
sending said unique identification code by said application program from said electronic device with Internet access to said central control unit;
associating by said central control unit said unique identification code to said data of said user;
sending to said notification server, when a change of said monitored data is detected by said central control unit, a notification user list, said notification user list containing the unique identification code associated with said user associated with said changed data;
sending said notification message by said notification server to each electronic device associated with a respective unique identification code of said notification user list.

3. Method, according to claim 2, wherein said electronic device with Internet access is selected from the group consisting of:
a smartphone;
a tablet;
a notebook;
a PC;
a TV.

4. Method, according to claim 1, wherein an input step is provided of a data item, or a change of at least one data item, by an administrator, said administrator enabled to carry out said input step through a back-office interface of said predetermined web page, said input step causing said change of said data and then generating said modified data.

5. Method, according to claim 4, wherein said input step provides the following operations:
input by said administrator of an event in said database and indicating at least one time value, in particular a data and/or a time of said event, said event selected from the group consisting of:
a single match;
a plurality of matches;
a plurality of matches organized as a tournament bracket;
a plurality of matches organized as a championship;
a combination thereof;
subscription by an individual and/or of an organization to said event.

6. Method, according to claim 1, said step of sending said notification message to said user is made directly by said central control unit, said notification message selected in this case among:
a notification message to said social network to which said user belongs;
a notification message to said e-mail address;
an SMS, or an MMS, sent to said telephone number of said user;
a combination thereof.

7. Method, according to claim 1, wherein said notification message is associated with a visual and/or sound alarm adapted to warn said user associated with said changed data that the notification message has been received by an interface device.

8. Method, according to claim 1, wherein between the acquisition step and the transmitting step a processing step by a program means is provided of said stream of audio and/or video data, said processing step adapted to compress said stream of audio and/or video data for reducing said display resolution of said stream of audio and/or video data from said predetermined display resolution to a predetermined final resolution.

9. Method, according to claim 1, wherein a step is provided of:
additional acquisition of an additional stream of audio and/or video data by an auxiliary video camera adapted to point to said user associated with said event and/or said individual and/or said organization;
sending said additional stream of audio and/or video data to a predetermined streaming server adapted to transmit said stream of additional audio and/or video data to a predetermined additional streaming channel.

10. Method, according to claim 9, wherein said transmission channel adapted to transmit said additional stream of audio and/or video data is integrated in a display device arranged near to, or at, the area where said event is carried out.

11. Method, according to claim 1, wherein said acquisition step provides: a contemporaneous acquisition of a plurality of events through a plurality of video cameras, each video camera of said plurality adapted to detect a respective stream of audio and/or video data having a determined display resolution and concerning a respective event;
controlling said plurality of streams of audio and/or video data by a program means and compressing at least one stream of said plurality, if the size of said plurality of streams of audio and/or video data is higher than the size of the band used for sending said plurality of streams of audio and/or video data to said streaming server, in a way to decrease its the size;
transmitting each stream of audio and/or video data of said plurality of computed streams from said streaming server to respective streaming channels.

12. Method, according to claim 1, wherein before the selecting step the preliminary steps are provided of:
subscription by said user through said predetermined web page to said management service of events, said enrolment comprising an input step of personal data of said user, said personal data comprising:
a user name;
an alphanumeric code of access, or password;
and at least one additional personal data item selected from the group consisting of:
an e-mail address;
a telephone number of said user;
an indication of a social network to which said user belongs;
a user geographic area, in particular an address of residence, or an address of domicile, or an IP address from which said user connects to said web page through said electronic device of interface.
In particular, the step of access of the user to the web page of interface provides the step of:
logging in of said recorded user to said predetermined web page through said interface device using a user name and an alphanumeric code of access, or password.

13. Method, according to claim 1, wherein said step of access of said user to said web page of interface provides the step of:
logging in of said recorded user to said predetermined web page through said interface device using a user name and an alphanumeric code of access, or password.

14. Method, according to claim 5, wherein the central control unit, once detected a change in the data, is configured to compute the waiting time to the event, said sending step of said notification message being carried out when said computed waiting time to a determined event, or associated with said selected individual, or to said organization, is less than a predetermined threshold time value t*.

15. Method, according to claim 14, wherein when the waiting time to said determined selected sport event is less than the threshold time value t*, a procedure is provided comprising a plurality of sending steps of notification messages, said plurality of sending steps comprising a predetermined number of sending steps at predetermined intervals of time.

16. Method, according to claim 1, central control unit detects said change the following steps are, furthermore, provided:
accessing by said central control unit and/or said electronic device provided with an Internet access, to a contact book of said associated user, said contact book selected from the group consisting of:
a contact book of said telephone number;
a contact book of said social network to which said user belongs;
a contact book of said e-mail address of said notified user;
and a sending step of an additional notification message to at least one contact of said contact book, said additional notification message selected from the group consisting of:
a notification message to said telephone number;
a notification message to said social network to which said user belongs;
a notification message to said e-mail address;
a combination thereof.

17. Method, according to claim 1, wherein said streaming channel is integrated in the predetermined web page available via Internet by said users.

18. Method, according to claim 1, wherein said notification message contains a link to the predetermined web page in which the streaming channel is integrated.

19. Method, according to claim 1, wherein said at least one user has a contract with the service selected from the group consisting of:
a television transmitting station;
a radio transmitting station;
said user that has a contract with the service adapted to transmit said selected sport event via an own channel that has a contract with the service, in particular a satellite channel, or digital terrestrial channel, or a streaming channel through the streaming server.

20. Method, according to claim 1, wherein said acquisition step is carried out by means of a plurality of video cameras, each video camera of said plurality adapted to take a stream of audio and/or video data concerning a same event to a respective predetermined display resolution, or dimension, obtaining a plurality of streams of audio and/or video data that are sent to said streaming server, said streaming server adapted to select at least one stream of audio and/or video data of said plurality on the basis of said display resolution, or dimension and to transmit said selected stream of audio and/or video data of said plurality to a respective streaming channel.

21. Method, according to claim 1, wherein said acquisition step is carried out by means of a plurality of video cameras, each video camera of said plurality arranged to acquire said event at a predetermined display resolution and wherein in said web page of interface a list of said plurality of video cameras with the related resolution of acquisition is shown, said user enabled to select a video camera from said plurality in such a way that views said transmission streaming of said event at the resolution associated with said selected video camera.

22. Method, according to claim 8, wherein said final resolution can be determined on the basis of a plurality of predetermined parameters associated with said data concerning said event and/or said individual and/or said organization, the higher the value of said predetermined parameters the higher said display resolution.

23. Method, according to claim 8, wherein the processing step is adapted to compress said stream of audio and/or video data up to a determined final resolution that is compatible with the size of the band available to the streaming server for said transmission.

24. Method, according to claim 1, wherein said sending step of said stream of audio and/or video data of said event to said streaming server is preceded by an activation step, said activation step comprising the following steps:
arranging at least one identification element on a garment, or an accessory, worn by at least one individual who participates to said event, said identification element containing an identification code;
reading said identification code by a reader device;
transmitting said identification code to a control means, said control means adapted to carry out a verification step during which a read identification code is compared with a predetermined identification code, said sending step of said stream of audio and/or video data occurring if said verification step has a positive result.

25. Method, according to claim 24, wherein said reading device and said element of identification are adapted to communicating by a transmission selected from the group consisting of:
radio transmission;
infrared transmission;
WiFi transmission;
Bluetooth transmission;
transmission by cable;
transmitting a biometric value;
transmitting a bar code;
transmitting a QR code;
transmitting an ID number.

26. Method, according to claim 1, where the steps are provided of:
arranging a first NFC device, or Near Field Communication, on a garment, or an accessory, worn by a first individual who participates to said event, said first NFC device comprising a first NFC sensor;
arranging a second NFC device, or Near Field Communication, on a garment, or an accessory, worn by a second individual who participates to said event, said second NFC device comprising a second NFC sensor;
carrying out an NFC communication between said first and said second NFC sensor, when said first and said second NFC device are arranged within a determined distance;
authenticating said first and of said second individual on the basis of said NFC communication and providing an authorization to send said stream of audio and/or video data if said authentication has a positive result.

27. Method, according to claim 1, wherein a loading step is, furthermore, provided of said data on said database, said loading step being carried out by a user selected from the group consisting of:
a administrator having preliminary authorization;
at least one individual;
at least one organization,
a combination thereof.
